(19) United States
(12) Patent Application Publication
(10) Pub. No.: US 2006/0261720 A1
(43) Pub. Date: Nov. 23, 2006

(54) Production of flat dielectrically impeded discharge lamps

(76) Inventor: Ahmet Oran, Giengen (DE)

Correspondence Address: OSRAM SYLVANIA INC, 100 ENDICOTT STREET, DANVERS, MA, 01923, US

(21) Appl. No.: 11/429,274

(22) Filed: May 8, 2006

(30) Foreign Application Priority Data
May 9, 2005 (DE) 10 2005 021 303.0

(51) Int. Cl. H01J 5/48; H01J 5/50

(52) U.S. Cl. 313/318.01

(57) ABSTRACT

The invention relates to the production of dielectrically impeded discharge lamps having a flat discharge vessel. In order to avoid strains and the need for pressure adaptations in a vacuum furnace, during joining of the discharge vessels gaps are left in a frame of the discharge vessel through which at least pressure equalization, or else evacuation, flushing and filling steps can be performed.

### TECHNICAL FIELD

This invention relates to the production of dielectrically impeded discharge lamps having flat discharge vessels.

### BACKGROUND ART

Dielectrically impeded discharge lamps are known per se. There, at least the anodes, frequently also all electrodes, are separated by a dielectric layer from the gaseous discharge medium in the discharge vessel. Such dielectrically impeded discharge lamps (or else “silent discharge lamps”) can be implemented with different geometries. In addition to other technical properties they are also of interest because of the good possibility of implementing discharge vessels of flat shape, in particular for backlighting display screens, monitors, display devices and the like, or else for general illumination.

Such flat discharge vessels for dielectrically impeded discharge lamps usually comprise a baseplate and a cover plate, between which a frame is located in many instances. The plates enclose a discharge space together with the frame. The term “flat” signifies that the planar extent of the discharge vessel, that is to say the edge lengths of the plates, is substantially greater than the thickness, perpendicular thereto, of the discharge vessel.

The discharge vessel must be “joined”, that is to say initially separate individual parts must be joined to one another, something which is generally done by fusing glass solder in a furnace. Before the final sealing, the discharge space connected by the discharge vessel must be freed from contamination, for example binder residues emerging from the glass solder during heating, and evacuated as well as filled with the discharge medium.

In this case, one process step consists in completely and tightly sealing the discharge vessel after filling with the discharge medium. This occurs in the prior art by virtue of the fact that, inter alia, spacers present in any case between the baseplate and the cover plate for reasons of stability were placed on glass solder “cushions” and thereby held the cover plate so high that a gap remained between the cover plate and frame. Starting from a specific temperature, the cover plate was then lowered onto the frame through a softening of the glass solder cushions and a corresponding sinking of the spacers, and joined to the said frame in turn by softened glass solder. It is also known as an alternative to this to hold the cover plate high by means of glass solder cushions between the cover plate and the frame, and to lower it by softening.

### DISCLOSURE OF THE INVENTION

The present invention is based on the technical problem of specifying with regard to the required sealing of the discharge vessel advantageous production methods for dielectrically impeded discharge lamps having a flat discharge vessel, and of specifying a correspondingly produced discharge lamp.

The invention is directed to a method for producing a dielectrically impeded discharge lamp having a flat discharge vessel, in the case of which a frame, a baseplate and a cover plate are joined and these parts are joined by fusing glass solder, further comprising that the frame leaves a gap between the frame parts, for the joining of these parts, upon joining the gap is retained as access to the interior of the discharge vessel, and after the joining glass solder runs into the gap owing to heating of the discharge vessel in a furnace, and thereby seals this gap, and thus the discharge vessel, and a correspondingly produced discharge lamp.

Preferred refinements are specified in the dependent claims and will be explained in more detail below. Features disclosed thereby and also in the exemplary embodiment are determinative both with regard to the aspect of method and with regard to the aspect of equipment, without an explicit detailed distinction being made here therebetween.

The invention proceeds in the most general sense from a joining of a cover plate, a frame and a baseplate by fusing glass solder. In this process, the frame can either already be permanently applied during mounting of the cover plate on the baseplate, or only rest thereon or else be designed in one piece with the baseplate or, on the other hand, also be joined to the cover plate itself or be designed in one piece therewith. However, it is preferred within the scope of the invention that during mounting of the cover plate the frame be located on the baseplate, that is to say be permanently applied, or rest thereon or be designed in one piece with the baseplate there. The cover plate is joined to the frame by means of glass solder, something which is known per se, as already stated above.

In a departure from the prior art, however, the frame already has at least one gap between frame parts, for example in a corner, before the parts are joined, in particular before the mounting of the cover plate. When the parts are joined, this gap still continues to exist and serves as access to the discharge space, that is to say for pressure equalization or filling with the discharge medium and, if appropriate, prior evacuation, flushing and the like. According to the invention, the aim is then for the gap, and therefore the discharge vessel, to be sealed by having softened glass solder then run into the gap. To this end, the discharge vessel is heated up to a sufficient temperature in a furnace in which, for example, prior evacuation steps and flushing steps and, in any event, filling with discharge medium is carried out. The aim in this case is for the glass solder to flow into the gap owing to gravitation forces and/or capillary forces, preferably owing to gravitation forces, that is to say from above to below.

In a departure from the prior art, this process can be conducted such that sealing is not performed until the glass solder has become capable of being deformed in a relatively liquid and not only viscous fashion. Since specific minimum temperatures are required for joining the discharge vessel, in the case of the procedure outlined according to the prior art there is the problem of the glass solder cushions already softening at temperatures that are lower than the maximum discharge vessel temperature, and thus softening at an earlier point in time such that the already closed discharge vessel is heated still further. The result of this is, firstly, a thermally induced internal pressure rise, and thus the necessity of likewise raising the furnace pressure. Secondly, as the inventor has observed, stresses that can lead to increased rejection rates or failure rates occur and are “frozen” in the lamp.

These difficulties can be avoided in the case of the invention because the glass solder does not become sufficiently flowable and thus seal the gap until reaching a temperature, and thus at an instant at which the glass solder also otherwise produces tight joints. There is thus no need for any substantial further rise in temperature.

Independently thereof, however, the invention can also be advantageous for other reasons, for example in order to be able to dispense with the abovementioned glass solder cushions.

A preferred design of the method mounts the frame as a part separate from the baseplate and the cover plate, specifically particularly in the form of at least two separate frame parts between which the gap remains. The joint between the frame and the baseplate can be performed, in turn, by glass solder. This joining step, and also the complementary step of joining the frame and cover plate are preferably performed in common with the inventive sealing of the gap.

When the frame is mounted in the form of at least two separate parts, the gap can exist in a space between these two parts at least at one point or preferably also at two points. For example, the two frame parts could be halves of a rectangular frame that are separated by a diagonal, that is to say set squares that consequently leave gaps at two diagonally opposite corners.

It is particularly preferred to mount the frame in the form of four separate straight rods such that gaps remain at four corners of a rectangle. The straight rods can be produced with particular ease and cost effectively. A number of four gaps improves the ability to access the discharge space for pumping and filling purposes, without substantially complicating the method according to the invention.

The glass solder that is intended according to the invention for sealing the gaps is preferably applied to the cover plate before the latter is mounted—with or without a joining frame. For example, it can be dabbed on or spread on in the usual form capable of spreading, and then be dried. It is, of course, also possible in a departure therefrom to proceed, for example, by mounting or clamping glass solder molded parts in the region of the top side of the gaps.

A further refinement of the invention provides a holding frame in which the discharge vessel is held during joining after the mounting of the top plate. Consideration is given here, in particular, to a perforated sheet frame, made from VA steel, for example. The holding frame can also already be present before the mounting of the cover plate, in order to ensure mounting with an accurate fit, and to help to avoid subsequent corrections by transverse displacement in the case of which the frame parts could, in turn, slip. Again, the holding frame could already enclose the baseplate during mounting of the frame or of the frame parts, but will rather have a disturbing effect here in many instances, because the frame parts do not offer any large areas comparable to the cover plate in order to be gripped from above, and so a corresponding manipulation device could collide with the holding frame.

Consideration is given as a manipulation device, in particular for the frame or for the frame parts, to a vacuum holding device that is designed for sucking in the top side. This vacuum holding device can be used to grip the frame parts and preferably dip them into glass solder and then mount them.

After being mounted, the cover plate can additionally be weighed down, for which purpose it is preferred to use a glass plate corresponding at least approximately in format. Consideration is given, in particular, to a Robax plate, that is to say a plate made from a heat resistant glass with a relatively low expansion coefficient. For reasons of symmetry and in order to avoid stresses, a similar plate can preferably lie below the baseplate such that then the discharge vessel assembled as a whole but still not yet finally joined is held between this lower plate and the upper (Robax) plate and the holding frame.

The inventive sealing of the discharge vessel can advantageously be fashioned such that it is not performed until the glass solder has been relatively extensively liquefied, because it is not until then that the glass solder flows into the gap under the action of gravitation force or capillary force. The process according to the invention is therefore preferably to be configured such that once the appropriate temperature has been reached, that is to say after the sealing of the discharge vessel there is no longer any substantial further temperature rise, and therefore it is possible to avoid the compensation of a rise in internal pressure in the lamp and to avoid stresses in the lamp. However, this conduct of the process is not mandatory, because, as stated at the beginning, the invention can also be selected, and appropriately designed with reference to other advantages.

### BRIEF DESCRIPTION OF THE DRAWINGS

The invention is explained in more detail below with the aid of an exemplary embodiment. In the drawing:

FIG. 1 shows a plan view schematic of a baseplate as starting point of the production method according to the invention,

FIGS. 2+3 show the baseplate after further method steps,

FIG. 4 shows a sequence of three schematics illustrating the principle of mounting frame parts,

FIG. 5 shows a holding frame for the inventive method,

FIG. 6 shows a cover plate with glass solder structures applied,

FIG. 7 shows a schematic side view for illustrating the position of the discharge vessel parts before sealing, and

FIG. 8 shows a schematic side view for illustrating the position of the discharge vessel part after sealing.

### BEST MODE FOR CARRYING OUT THE INVENTION

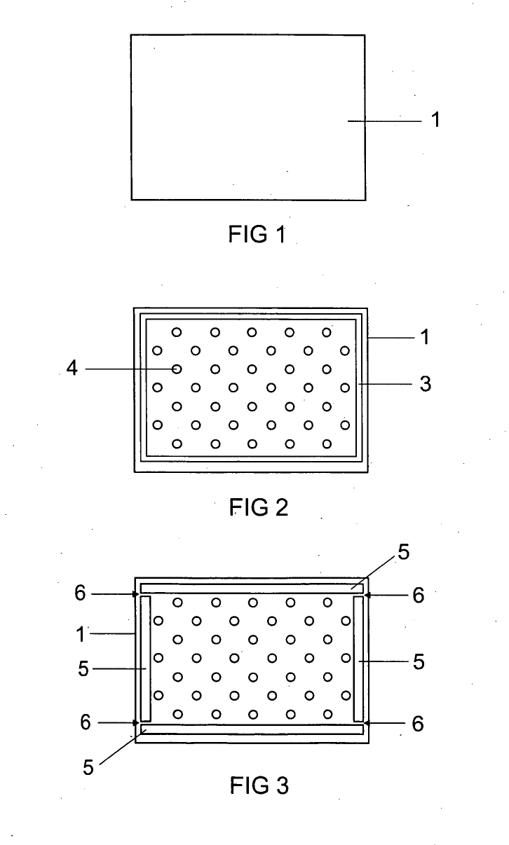

FIG. 1 shows a glass plate 1 as baseplate for a dielectrically impeded discharge lamp to be produced according to the invention. The glass plate 1 already bears electrode structures and contact structures, produced by screen printing, that are of no further interest and therefore are not illustrated in detail.

The baseplate 1 from FIG. 1 is to be seen in FIG. 2 with a dispensed solder edge 3. This solder edge 3 solidifies by drying. Furthermore, glass pins 4 are applied as spacers in the case of this exemplary embodiment. In the finished discharge vessel, these spacers 4 support the baseplate 1 and a cover plate, shown in FIG. 5, against one another in order to avoid mechanical damage as a consequence of the underpressure in the discharge vessel or owing to flexural stress.

In the further course of the method, straight glass rods are gripped as frame parts 5 firstly with the aid of a vacuum suction device (not illustrated), then dipped into liquid glass solder and, as illustrated in FIG. 3, mounted on the baseplate. In this process, there remain in the corners clearances approximately 2 mm wide at which the glass rods 5 come closest to one another. Four gaps 6 result thereby. Before the mounting and the coating of the back of the glass, the glass rods 5 can be coated, lying next to one another, with reflector layers and phosphor layers, as is known per se in the production of such lamps.

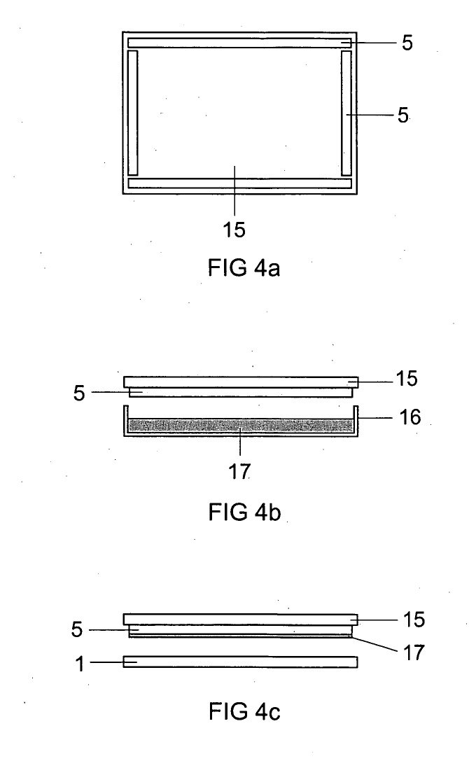

FIG. 4 shows the frame parts 5 in a schematic illustration on a vacuum plate 15. The middle illustration shows how the vacuum plate 15 with the frame parts 5 is lowered into an immersion bath 16 with glass solder 17. The right-hand illustration shows the vacuum plate 15 with a frame part 5 that is sucked in thereunder and is wetted with glass solder 17 on its underside. The frame parts 5 are deposited on the baseplate 1 in this form.

FIG. 5 shows a holding frame 7 made from V2A perforated sheet with a Robax glass plate 9 resting therein on holding lugs 8 of the holding frame 7. The baseplate 1 fitted in accordance with FIG. 3 is inserted into this joining receptacle and freed in a furnace from binder (from the glass solder) and prejoined, that is to say prefastened.

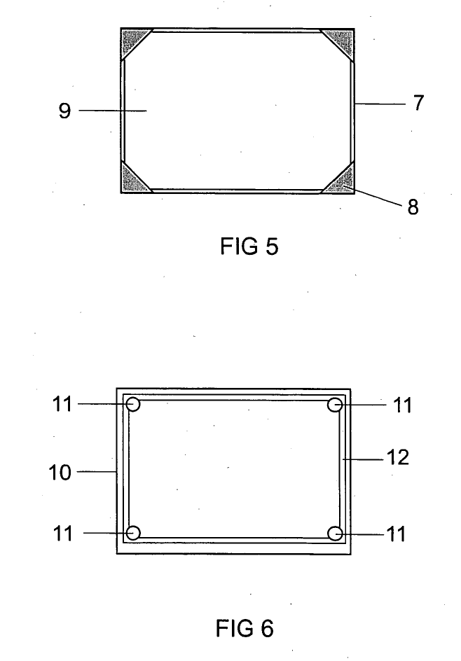

In accordance with FIG. 6, a cover plate 10 is again provided with glass solder heaplets 11 in its corners and otherwise with a solder edge 12.

After drying, the cover plate 10 from FIG. 6 is laid into the holding frame 7 with downwardly pointing glass solder structures 11 and 12 onto the frame parts 5.

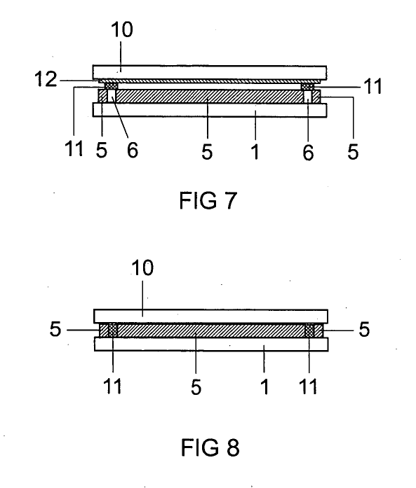

In this case, a second Robax glass plate is laid onto the cover plate 10 (not illustrated). In this form, the assembled, but not yet joined, evacuated and filled discharge vessel can be introduced into a vacuum furnace in which Xe gas is then filled at approximately 440° C. after appropriate evacuation steps and flushing steps at 310 mbar. At this temperature and this pressure, the discharge vessel is still open. FIG. 7 shows this more clearly. The glass solder heaplets, which are illustrated here as rectangles for the sake of simplicity, still hold the cover plate 10 over the frame 5 such that not only the gaps 6, but also a slit further remain free over the frame parts 5. When a temperature of approximately 500° C., at which the glass solder softens, but is still relatively viscous, is reached, the cover plate 10 firstly sinks onto the frame 5, the gaps 6 continuing to remain open and thus to ensure pressure equalization. After the melting temperature of the glass solder is reached at approximately 550° C., the gaps 6 are closed because the glass heaplets 11 flow off into the gaps as a result of gravity, as FIG. 8 shows. The capillary action and wetting property further assists here in giving rise to a truly tight join.

The upper Robax plate serves for weighing down. Incidentally, the lower Robax plate 9 and the upper Robax plate are virtually identical, and so there is a very symmetrical distribution of heat, above all during cooling, and thus a minimal straining of the lamp. The holding frame 7 keeps together the packet of plates described. The two Robax plates 9 and the V2A perforated sheet frame 7 are adapted to the discharge vessel with dimensional accuracy.

In this exemplary embodiment, the advantages of avoiding stresses in the lamp and, in particular, of avoiding a substantial heating step after sealing of the discharge lamp are to the fore. In this connection, the invention can even be combined with the conventional measure of spacers 4 that are somewhat excessively high standing owing to glass solder cushions or similar structures, and that slots can also initially remain over the frame parts 5 and below the cover plate 10 during joining of the lamp. This has already been explained with the aid of FIG. 7, in which the glass solder heaplets 11 assume the function of the glass solder cushions. The slits increase the pumping cross section up to a furnace temperature of approximately 500° C. Starting from this temperature, the cover plate 10 slowly sinks such that there remain only the abovementioned gaps 6, which can thus at least accomplish a pressure equalization up to 550° C. The gaps can be particularly small in this case.

1. A method for producing a dielectrically impeded discharge lamp having a flat discharge vessel, in the case of which a frame, a baseplate and a cover plate are joined and these parts are joined by fusing glass solder, further comprising that the frame leaves a gap between the frame part, for the joining of these parts, upon joining the gap is retained as access to the interior of the discharge vessel, and after the joining glass solder runs into the gap owing to heating of the discharge vessel in a furnace, and thereby seals this gap, and thus the discharge vessel.

2. The method as claimed in claim 1, in which the cover plate is mounted on the frame on the baseplate during joining.

3. The method as claimed in claim 2, in which the frame is mounted on the baseplate as a part separated from the baseplate, before the cover plate is mounted.

4. The method as claimed in claim 3, in which the frame is mounted in the form of at least two separate parts, the gap remaining between these parts.

5. The method as claimed in claim 4, in which the frame is mounted in the form of four separate rods, gaps remaining between these rods in the corners of the frame.

6. The method as claimed in claim 1, in which before the joining of the parts glass solder is applied to the cover plate at a position that is arranged above the gap after the joining.

7. The method as claimed in claim 2, in which the mounting of the cover plate, and the subsequent heating of the discharge vessel are performed in a holding frame, preferably a perforated sheet frame, that encloses the baseplate and the cover plate with a good fit.

8. The method as claimed in claim 2, in which for the purpose of mounting on the baseplate, the frame or the frame parts are gripped with the aid of a vacuum holding device and dipped into glass solder before being mounted.

9. The method as claimed in claim 1, in which during heating of the discharge vessel in order to seal the gap, the cover plate is weighed down, preferably by a glass plate laid on top.

10. The method as claimed in claim 7, in which during heating in order to seal the gap the discharge vessel is held laterally in the holding frame with the aid of a lower supporting plate arranged under the baseplate, and an upper plate resting on the cover plate in order to weigh it down.

11. The method as claimed in claim 1, in which no substantial further temperature rise occurs after the sealing of the gap.

12. A dielectrically impeded discharge lamp having a flat discharge vessel, produced with the aid of a method as claimed in claim 1, which has a frame between a base plate and a cover plate, a gap between the frame parts being sealed by fused and resolidified glass solder.

13. The method as claimed in claim 9, in which during heating in order to seal the gap the discharge vessel is held laterally in the holding frame with the aid of a lower supporting plate arranged under the baseplate, and an upper plate resting on the cover plate in order to weigh it down.

14. A dielectrically impeded discharge lamp having a flat discharge vessel, produced with the aid of a method as claimed in claim 2, which has a frame between a base plate and a cover plate, a gap between the frame parts being sealed by fused and resolidified glass solder.

15. A dielectrically impeded discharge lamp having a flat discharge vessel, produced with the aid of a method as claimed in claim 3, which has a frame between a base plate and a cover plate, a gap between the frame parts being sealed by fused and resolidified glass-solder.

16. A dielectrically impeded discharge lamp having a flat discharge vessel, produced with the aid of a method as claimed in claim 4, which has a frame between a base plate and a cover plate, a gap between the frame parts being sealed by fused and resolidified glass solder.

17. A dielectrically impeded discharge lamp having a flat discharge vessel, produced with the aid of a method as claimed in claim 5, which has a frame between a base plate and a cover plate, a gap between the frame parts being sealed by fused and resolidified glass solder.

18. A dielectrically impeded discharge lamp having a flat discharge vessel, produced with the aid of a method as claimed in claim 6, which has a frame between a base plate and a cover plate, a gap between the frame parts being sealed by fused and resolidified glass solder.

19. A dielectrically impeded discharge lamp having a flat discharge vessel, produced with the aid of a method as claimed in claim 7, which has a frame between a base plate and a cover plate, a gap between the frame parts being sealed by fused and resolidified glass solder.

20. A dielectrically impeded discharge lamp having a flat discharge vessel, produced with the aid of a method as claimed in claim 8, which has a frame between a base plate and a cover plate, a gap between the frame parts being sealed by fused and resolidified glass solder.
